(19) United States
(12) Patent Application Publication
(10) Pub. No.: US 2008/0084634 A1
(43) Pub. Date: Apr. 10, 2008

(54) Devices and methods for storing data

(75) Inventors: James M. Henson, Reno, NV (US); Stephan R. Fuelling, Reno, NV (US)

Correspondence Address: KLARQUIST SPARKMAN, LLP, 121 SW SALMON STREET, SUITE 1600, PORTLAND, OR, 97204, US

(73) Assignee: Board of Regents of the Nevada System of Higher Education on Behalf of the University Nevada, Reno (US)

(21) Appl. No.: 11/903,816

(22) Filed: Sep. 24, 2007

Related U.S. Application Data
(60) Provisional application No. 60/846,786, filed on Sep. 22, 2006.

(51) Int. Cl. G11B 5/78

(52) U.S. Cl. 360/134

(57) ABSTRACT

Devices and methods are disclosed for storing data in manner that is readable and highly resistant to destruction. An exemplary data-storage device includes a medium; multiple, discrete, data-containable loci located in or on the medium; and an alignment restraint. Each data-containable locus includes magnetically responsive particles that are magnetically alignable in a respective selected one of at least two selectable non-parallel directions by application thereto of a respective magnetic field. The selected direction corresponds to a respective unit of data and/or data state stored at the locus. The alignment restraint is configured (e.g., as a characteristic of the medium or of a carrier for the particles) to retain the respective magnetic alignments of the particles in the loci after removal of the respective magnetic fields. The medium can have various configurations such as a card, document, or other suitable configuration.

### PRIORITY CLAIM

This application claims priority to, and the benefit of, U.S. Provisional Application No. 60/846,786, filed on Sep. 22, 2006, which is incorporated herein by reference in its entirety.

### FIELD

This invention relates to, inter alia, data-storage devices having applications in, for example, information storage, data security, intelligent media, and any of various other applications. More specifically, the data-storage devices contain data that can be stored and read in a secure manner and that cannot be easily modified or erased.

### BACKGROUND

Various schemes for storing data magnetically are known that permit the stored data to be recalled conveniently for use. For example, recording sounds and/or images on magnetic tape, comprising a thin, flexible, ribbon-like substrate coated with a magnetic medium, is well known and has been used for years. The sound or image data can be stored in analog form or digital (binary) form. The recorded data is read off the tape using an appropriate “reader.” Another major use of magnetic data storage is floppy disks and hard disks used with virtually every laptop or larger computer currently in use. These devices normally store data in digital binary form.

The general concept of storing data magnetically is also used in most, if not all, transactions involving credit cards, debit cards, identity cards, passcards, phone cards, transportation tickets, and the like. Many types of such cards and analogous devices include one or more strips of magnetic data-storage medium that can be read and processed as required in the course of the transaction. This form of data storage is aimed at providing some degree of security of the transaction, and also greatly increases the speed and number of transactions that an be executed, per unit time.

Yet another form of magnetically based data storage is the use of magnetic “inks” on transactional and commercial documents such as bank checks, deposit slips, securities, order sheets, and the like. For example, account numbers and other information typically is printed along the bottom margin of bank checks using a type of magnetic ink and a particular font. Some consideration has been given to using analogous inks on currency as an anti-counterfeiting measure. In this latter regard, use of magnetic-based compositions has been combined with other techniques such as diffractive techniques. An example of this is discussed in U.S. Pat. No. 6,902,807 to Argoitia, incorporated herein by reference.

A disadvantage of these various conventional magnetically based data-storage techniques is that the data-storage capacity is limited, at least in part, as a result of the data being stored in binary form. At a particular locus in a binary data-storage device, a data bit is stored as one of two possible states, namely “0” or “1”. Consequently, storing binary data requires a large amount of data-storage space. Another disadvantage is that the resolution of data storage and recall is limited in these devices largely by the devices' two-dimensional configurations.

Another disadvantage is the ease in which the data can be destroyed or at least corrupted, accidentally or deliberately. For example, passage of a credit card or debit card over or through a strong magnetic field can erase or change some or all the information on the card's magnetic strip.

Another disadvantage of conventional data-storage techniques is the vulnerability of the data to theft or unscrupulous use. Theft simply requires the thief to have a magnetic reader, and the thief need not have possession of the data-storage device any longer than the instant during which the device is being covertly read.

Hence, there remains a need for improved data-storage devices and methods.

### SUMMARY

The disadvantages of conventional devices and methods are addressed by data-storage devices and methods as disclosed below.

An embodiment of a data-storage device comprises a medium; multiple, discrete, data-containable loci located in or on the medium; and an alignment restraint. Each data-containable locus includes magnetically responsive particles that are magnetically alignable in a respective selected one of at least two selectable non-parallel directions by application thereto of a respective magnetic field. The selected directions correspond to respective units of data (e.g., respective data “states”). The alignment restraint is configured to retain the respective magnetic alignments of the particles in the loci after removal of the respective magnetic fields.

The alignment directions are not limited to two directions, and the directions need not be orthogonal to each other. An example is described herein in which the loci are selectively aligned to respective directions in a range of eight possible directions.

The medium can be three-dimensional or substantially two-dimensional. With a two- or three-dimensional medium, the loci can be arranged on a surface of the medium and/or can be dispersed three-dimensionally in at least a portion of the medium. The loci can be discrete locations, in a distribution of magnetically responsive particles on or in the medium, that are selected for receiving respective units of data. An example three-dimensional medium is configured generally with a “credit-card” shape or the like having a substantial thickness dimension. An example two-dimensional medium is a sheet-like or document-like configuration. With either configuration of medium, the loci can be situated in a particular region or alternatively be uniformly distributed in or on the medium.

The medium can have a composition that fluidizes upon exposure to an energy beam and that returns to a non-fluid condition upon removal of the energy beam. In these embodiments the loci are situated to allow selective exposure thereof to the energy beam to fluidize the medium at the selected locus. The magnetically responsive particles of the selected locus are thus allowed to align with a magnetic field applied to the locus. The alignment restraint in this instance can be a characteristic of the medium by which the medium at a locus returns to a non-fluid condition upon removal of the energy beam from the locus.

Alternatively, the magnetically responsive particles in the loci can be suspended in a carrier substance (“carrier”) that can be cured (rigidified) and that also can be re-fluidized. For example, the loci can be formed as respective dots, of a suspension of magnetically responsive particles in the carrier, formed on a surface of the medium. In this example the alignment restraint is a characteristic of the carrier by which the carrier in a locus inhibits changes in magnetic orientation of the respective particles in the locus after magnetic orientation of the respective particles.

Further alternatively, the loci can be applied (e.g., as a magnetic “ink”) to a surface of the medium and selectively exposed to respective magnetic fields as or before the ink at the loci cures.

An exemplary method for storing data comprises providing a supportive medium having at least two dimensions. On or in the at least two dimensions an amount of magnetically responsive particles is distributed that is sufficient to provide multiple data-containable loci on or in the medium, respectively. Each locus contains respective magnetically responsive particles that are magnetically alignable in a respective one of at least two non-parallel directions to provide at least two respective, distinguishable states of data. To provide the loci with respective units of data, the respective data units are added to the loci by subjecting the loci to respective directions of magnetic fields corresponding to the respective data units in the loci.

For example, the medium can be provided with a region containing a distribution of magnetically responsive particles. In this example, adding respective data units comprises: (a) selectively subjecting the loci in the region to an energy beam sufficient to fluidize the respective loci, and (b) while the loci are fluidized, subjecting the locus to a respective direction of a magnetic field so as to add the respective data to the locus.

The various advantages of the subject devices and methods include, inter alia:

(1) The information/data density for the medium is greater than for conventional media. (2) The medium is immune or at least highly resistant to dirt, dust, and other environmental contaminants. (3) Scratches and scrapes on the surface generally do not degrade the medium. (4) The medium is resistant to data-erasure, either accidental or intentional. (5) The medium is not degraded by repeated reading. (6) The life-span of the medium is greater than of conventional media. (7) The medium can be used for covertly storing and encoding data and imagery including fingerprint and retinal-scan data. (8) The medium is difficult to counterfeit.

The foregoing and additional features and advantages of the invention will be more readily understood from the following detailed description, which proceeds with reference to the drawings.

### BRIEF DESCRIPTION OF THE DRAWINGS

FIG. 1 depicts a situation in the first representative embodiment in which magnetically responsive particles, that have been suspended in a curable liquid medium, are exposed to a first magnetic field as the medium is being cured. The particles thus become substantially “pre-aligned” with the first magnetic field. Pre-aligned particles represent a first data state.

FIG. 2 depicts an event in the first representative embodiment in which a laser beam is incident at a particular locus on or in the structure shown in FIG. 1. The incident beam causes a local heating of the cured medium at the locus, which converts the medium at the locus to a fluid (liquid) state. Meanwhile, the locus is exposed to a second externally applied magnetic field that causes the magnetically responsive particles in the fluidized locus to become aligned with the second magnetic field and thus assume a second data state. In this embodiment the second magnetic field is not parallel to the first magnetic field.

FIG. 3 depicts an event in the first representative embodiment in which a laser beam is incident at a particular locus on or in the structure shown in FIG. 2. The particular locus is different from the locus shown in FIG. 2. The incident beam causes a local heating of the cured medium at the locus, which converts the medium at the locus to a fluid (liquid) state. Meanwhile, the locus is exposed to a third externally applied magnetic field that causes the magnetically responsive particles in the fluidized locus to become aligned with the third magnetic field and thus assume a third data state. In this embodiment the third magnetic field is not parallel to either the first or the second magnetic field.

FIG. 4 depicts an exemplary manner in which data as stored can be spatially encoded. In the figure the data units are spatially encoded on or in the medium and then decoded in two dimensions using array (row, column) translation tables.

FIG. 5 depicts a situation in accordance with the second representative embodiment, in which loci, configured as “dots,” are print-deposited on a substrate, and the magnetically responsive particles in the loci are oriented in selected directions by application of respective magnetic fields before the loci become immobilized. In the figure an ensemble of loci is shown with three respective particle orientations that are not all orthogonal to each other.

### DETAILED DESCRIPTION

This disclosure is set forth in the context of various representative embodiments that are not intended to be limiting in any way.

As used in this application and in the claims, the singular forms “a,” “an,” and “the” include the plural forms unless the context clearly dictates otherwise. Additionally, the term “includes” means “comprises.” Further, the term “coupled” means electrically, electromagnetically, or optically coupled or linked and does not exclude the presence of intermediate elements between the coupled items.

In the following description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

In all current magnetic-storage media, the medium must retain the field associated with the binary information states. As noted above, this leaves the medium vulnerable at least to being erased in a conventional manner such as the presence of a strong magnetic field or heat. In various embodiments described below, this vulnerability is removed because, in general, the medium is pre-magnetized as part of the reading process. Hence, the medium cannot be demagnetized (erased) in the conventional manner and thus lose its information content. The stored data can be destroyed, of course, by destroying the medium itself such as by breaking, melting, or cutting the medium.

As used herein, a “data-storage device” is any device on which data is stored, according to the principles disclosed herein, and from which the stored data can be recalled or “read.” Hence, a data-storage device encompasses cards, documents, appliques, and things. Exemplary cards are “credit” cards, debit cards, identity cards, pass cards, inventory cards, membership cards, data cards, and the like. Exemplary documents are banknotes, currency, securities, bonds, contracts, identity documents, authenticity documents, tags, commercial documents, entertainment media, and the like. Exemplary appliques are stickers, decals, labels, placards, and the like. Exemplary things are computer memories, other electronically read memory devices, tapes, disks, chips, chip assemblies, packages, and the like, as well as apparatus including one or more of these.

### FIRST REPRESENTATIVE EMBODIMENT

This embodiment is exemplary of devices and methods for writing and storing data magnetically in a three-dimensional medium. In this embodiment magnetically responsive particles are added to and suspended (or otherwise distributed) in the medium while the medium is in a fluid, or “uncured,” state. Normal use of the embodiment is with the medium in a cured, rigid state. The suspension desirably is (but need not be) uniform throughout the medium. Generally, “fluid” means a state of matter that can flow; in the context of the current disclosure, “fluid” denotes a liquid state. The liquid can be a viscous liquid in which the magnetically responsive particles can be suspended. By distributing the particles in the liquid, the liquid is “doped” with the particles.

Desirably, the magnetically responsive particles are very small, having a mean or median diameter in the range of, for example, micro- or nano-sized particles. (The size range is not limited to the micro- and nano-range.) By “magnetically responsive” is meant that the particles have the ability, when exposed to an externally applied magnetic field under conditions in which the particles have freedom of movement, to become oriented to the magnetic field. To facilitate magnetic responsiveness in the particular medium, the particles can be appropriately shaped, such as oblong, and can be symmetrical or non-symmetrical in configuration. The magnetically responsive particles can be made of any material that responds in the noted manner to an applied magnetic field; such materials include, but are not limited to, iron, nickel, cobalt, iron oxide, and alloys and mixtures of these metals.

One manner of doping the uncured medium is to add the magnetically responsive particles to the medium to form a distribution (mixture or suspension) of the particles in the medium. Suspension is achieved using a suitable technique such as stirring or other agitation. Suspension can be facilitated by first suspending the magnetically responsive particles at relatively high concentration in a small amount of a low-viscosity carrier liquid, then adding the low-viscosity suspension to an amount of uncured medium having a higher viscosity. At completion of suspension, the resulting mixture desirably is uniform (substantially homogeneous) with respect to the distribution of the magnetically responsive particles in the medium. The mixture, still uncured, is transferred to a desired form or mold, or otherwise formed in a desired configuration (e.g., by forming a layer), and then cured (hardened). The depth of the form can be as desired for the thickness of the data-storage medium ultimately produced.

In an alternative manner of doping the uncured medium, the magnetically responsive particles are grown or deposited on a thin-film substrate, e.g., a suitable plastic substrate. The resulting particle-coated, thin-film substrate is submerged in uncured medium in a desired form, e.g., by placing the coated thin-film substrate in the form and adding uncured medium, or by placing the coated thin-film substrate in a form to which uncured medium has already been added, or simply by applying uncured medium as a layer to the coated thin-film substrate without using a form. Contact of the uncured medium as a layer with the thin-film substrate in this alternative embodiment causes release of the particles from the film. It is not necessary in this alternative embodiment to create a homogeneous mixture of magnetically responsive particles in the uncured medium.

The form or mold (if used) in which the medium is cured in this representative embodiment desirably is constructed of a material that does not weaken or obstruct magnetic fields applied to the medium contained in it. A similar criterion applies to the thin-film substrate used in the alternative embodiment. By way of example, the mold can be made of a suitable plastic or glass. The thin-film substrate can be made of, for example, a thin plastic film, a woven or non-woven web, a paper, or other suitable thin-film material.

In the alternative embodiment depositing the magnetically responsive particles on the thin-film substrate can be performed by any of various techniques including, but not limited to, sputtering, spraying, ink-jet printing, other types of printing, lithography. Spraying, ink-jet printing, and other wet-layering methods may be facilitated by suspending the particles in a suitable carrier liquid that desirably has low viscosity and desirably is rapidly removed by, for example, evaporation after application of the particles to the thin-film substrate. The carrier liquid desirably is one in which the magnetically responsive particles are readily dispersed without clumping or the like. Also, in this embodiment, the carrier liquid does not include a binder or the like that would cause the particles to adhere strongly to the substrate.

Curing of the medium results in formation of a three-dimensional structure, even if the aspect ratio is very low, comprising the magnetically responsive particles distributed in at least a portion of the cured medium. For example, the structure can have a shape that is similar, in relative length, width, and height dimensions, to a credit card. The resulting structure, whether or not having a credit-card configuration, is termed a “data-storage device.”

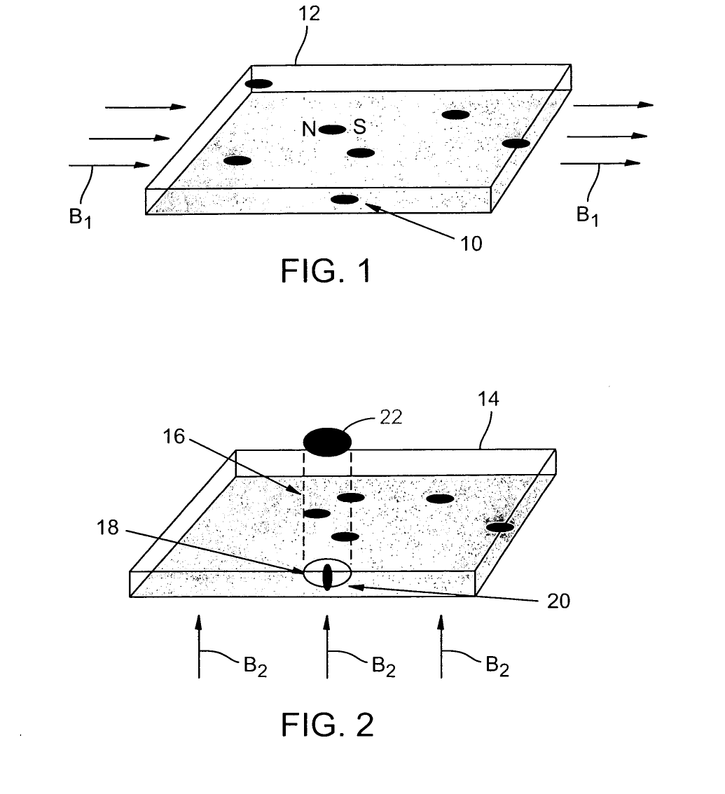

In this embodiment, as the medium is being cured, it is subjected to a first magnetic field to align substantially all the magnetically responsive particles in one direction. This is shown in FIG. 1, in which the first magnetic field B₁ causes the particles 10 in the fluid medium 12 to respond to the field by aligning in the direction of the field. This step is termed “pre-alignment” of the particles 10, which establishes a default alignment of the magnetically responsive particles unless the alignments of particles at specific loci in the medium 12 are changed, as discussed below. Pre-alignment is optional. Alternatively, the particles 10 can be left unaligned at this stage, by which is meant that the particles in the medium have substantially random magnetic orientations. The remaining description of this embodiment is set forth with the understanding that the magnetically responsive particles are pre-aligned.

After the fluid medium 12 containing the magnetically responsive particles 10 is cured (to a cured medium 14), in this embodiment a laser beam 16 (as an example “energy beam”) is moved (e.g., scanned or selectively placed) across at least a portion of the cured medium to appropriate discrete loci above or on the medium. Contact of the laser beam 16 at a particular locus 18 causes a local heating of the cured medium 14 at the locus, which fluidizes the medium at the locus, e.g., to a viscous-liquid state. Meanwhile, at least the locus 18 is exposed to a second externally applied magnetic field B₂, as shown in FIG. 2, which causes the magnetically responsive particle(s) 20 in the fluidized locus to become aligned with the second magnetic field. Desirably, the second magnetic field B₂ is at least not parallel to the first magnetic field B₁. The second magnetic field B₂ can be, for example, orthogonal to the first magnetic field B₁, but orthogonality is not required. Upon removal of the beam 16 from the locus 18, the medium 14 at the locus re-cures or otherwise returns to a substantially non-fluid state in which the particles at the locus are restrained to retain their magnetic orientations. Thus, the locus 18 receives and stores a respective unit of data.

Due to the extremely small size of the magnetically responsive particles with respect to the practical size of the loci, each locus usually will contain multiple particles. However, it is conceivable that a locus will contain only one magnetically responsive particle.

The laser 22 can be a diode laser, semiconductor laser, chemical laser, or other suitable type having sufficient power and having an appropriate wavelength and pulse frequency for fluidizing the cured medium 14 without damaging the medium. The laser beam 16 desirably is pulsed. The loci 18 should not be exposed to laser light 16 sufficiently to bring the particles to a temperature greater than the particles' Curie point (a function of particle size and particle material), at which point the particles would lose their ability to respond to a magnetic field.

If desired or necessary, the laser beam 16 can be conditioned to focus the beam at the desired loci (which can be in the thickness dimension of the medium 14). Exemplary ways of conditioning a light beam include use of refractive optics (e.g., lenses), reflective optics (e.g., mirrors), or a combination of refractive and reflective optics. An exemplary beam diameter is that of a beam used for reading a compact disk. An even smaller-diameter beam can have a greater ability to distinguish small and/or closely spaced units of data. The beam 16 can be sufficiently small to illuminate an area approximately filled by only one particle, depending upon the size of the particle relative to the beam diameter; however, in most applications, an area greater than the area of more than one particle will be illuminated.

As an alternative to a laser, the beam can be another type of energy beam such as a microwave beam or electron beam that is capable of locally heating and fluidizing the cured medium. Again, the main requirement is that the beam not raise the temperature of the particles past their Curie point and that the beam be sufficiently small, either inherently or by conditioning, for the desired sizes of loci. Microwave beams can be conditioned, including “focused,” by any of various techniques known in the art.

The composition of the medium can depend upon the particular application. A general category of media having advantageous properties for various embodiments as disclosed herein is “plastic.” To ensure that localized heating of the medium causes the desired fluidization of the medium, rather than chemical decomposition or destruction of the medium, at the locus, the medium desirably is one or more plastics known in the art as “thermoplastics.” Thermoplastics are generally plastics that, when in a rigid state, are not significantly cross-linked. Thermoplastics are in contrast to another class of plastics called “thermosets” that generally are cross-linked. Cross-linking of thermosets typically occurs during curing and results in the entire structure being composed of few, or even of one, molecule that cannot be melted. Consequently, with thermosets, excessive heating can cause actual destruction or other undesirable change of the structure that cannot be reversed by subsequent cooling. Also, depending upon the particular configuration and intended use of the data-storage device, the medium can be rigid or have some compliance (the latter being especially desirable for card-shaped devices). The medium need not be clear and colorless. Depending upon the application, the medium can be opaque and/or colored. Opaque or colored media can be provided by adding any of various other materials such as, but not limited to, fibers, colorants, non-magnetic particles, etc.

The external magnetic fields B₁, B₂ can be generated using any of various techniques and apparatus, such as opposing electrical coils. The strength of a field is selected based on the particular composition and achievable reduction in viscosity of the medium upon heating with the laser beam or other energy beam.

According to the method described above, by selectively exposing particle-containing loci in or on the medium to the first and second non-parallel magnetic fields, respective data units having at least a binary characteristic are written on or within the medium. Conventionally, binary data are typically written by selective application of two magnetic fields that are parallel to each other but opposite in direction (e.g., up and down).

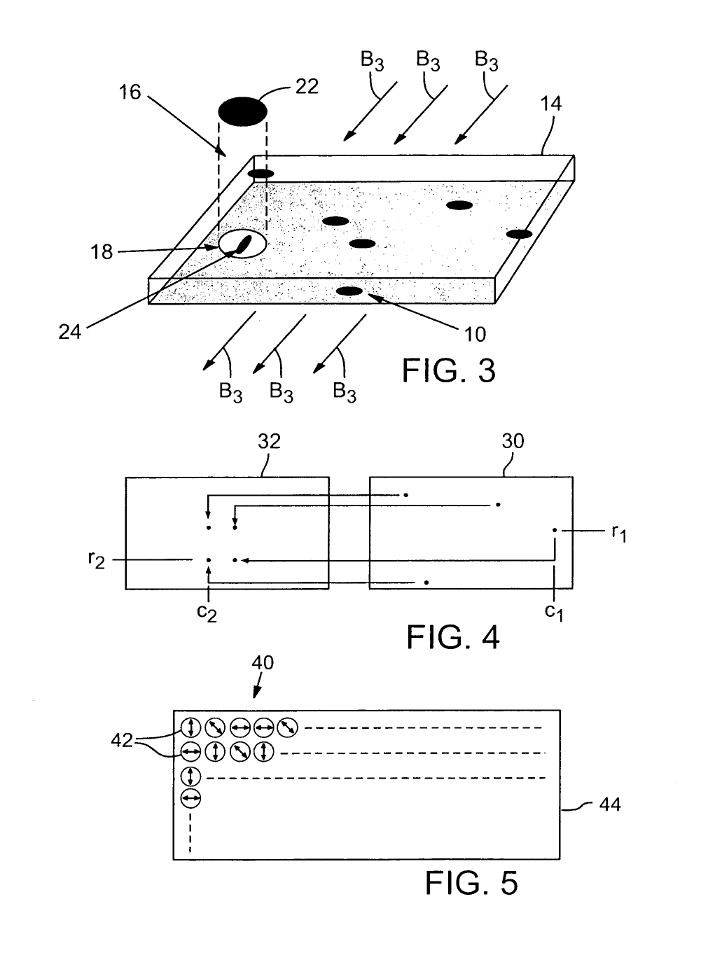

If the localized heating step, described above, is repeated for other selected loci in the presence of a third magnetic field B₃ oriented in a direction that is not parallel (e.g., orthogonal) to either of the previously applied fields B₁ and B₂, then the magnetically responsive particles 24 in each selected locus are oriented in the third direction, as shown in FIG. 3. In this embodiment, exposure of the particles to the third magnetic field confers at least three data states for each of the data units stored in the device. This ability to “write” data into the loci in three or more data states using at least two non-parallel magnetic fields is a particular advantage of this embodiment.

It is possible to align the respective magnetically responsive particles in other selected loci in other directions by applying the locus-heating step repeatedly in the presence of respectively oriented external magnetic fields. These different directions need not all be orthogonal to each other. (In fact, they cannot all be orthogonal if more than three magnetic fields are used.) The larger the number of orientations, the greater the number of data states and the greater the potential information content of the medium. But, the number of orientations cannot be infinite. Rather, the practical number of orientations approaches a limit, which depends on a number of factors including the spatial resolution of the energy beam and the number of magnetic-signal levels (corresponding to respective orientations), associated with a particular volume of particles, that can be distinguished by the sensor. For example, if eight separate orientations are used for data writing, then the loci can store respective data units each representing eight possible data states, compared to only two possible data states that are storable in conventional binary-data storage devices. In other words, in this example, each magnetized locus can store a data unit represented by any one of eight possible data states rather than only two states. Consequently, this example can store a correspondingly greater amount of data in the same space than a conventional binary storage device.

Loci can be combined to yield even greater storage capacity. For example, with eight possible orientations per locus, two loci on or in the medium can represent data selected from 8²=64 distinct values. Thus, data stored in such a medium can comprise a two- or three-dimensional array of N grey-levels (or other tone levels) sufficient to form a stored image, where each locus on or in the medium represents a respective “pixel” of the image.

The data can be read using, for example, a magnetic sensor as known in the art (for reading magnetic media) or an optical sensor (especially if the medium is transparent). A magnetic sensor can detect the magnetic fields associated with the loci even if the particles are not pre-aligned. But, alignment can be advantageous, resulting in concentration the flux lines in a direction in which the sensor can take advantage of. This and other representative embodiments do not represent an attempt to create media that retain magnetic fields, it is almost a necessity that the media be “pre”- or “re”-magnetized as part of the reading process. Pre-magnetization can be achieved by passing a magnet (e.g., a simple bar magnet) across the surface of the medium in one or more directions. Magneto-resistive (or other) heads or arrays of heads can then be used to detect changes in particle orientations as a function of field strength.

According to this embodiment, data also can be encoded, which substantially increases the security of the stored data. As shown in FIG. 4, data and/or imagery can be spatially encoded (30) in the medium and then decoded in two dimensions (32) using array (row, column) translation tables. To illustrate, again referring to FIG. 4, data located at (r₁, c₁) on or in the actual medium must be re-mapped to (r₂, c₂) during reading and decoding. In other words, the data-storage device is configured to receive data so that the actual spatial locations of the data as stored on or in the medium are incorrect, by which is meant that reading of the data without decoding it yields nonsense. A priori knowledge of the correct spatial location for each data locus (e.g., “pixel”) is used to construct the desired “sense” during reading and data decoding.

The significance of data-recording according to this embodiment is that the stored data in the medium cannot, from a practical standpoint, be erased or altered. Attempts at erasure or alteration typically will destroy the medium and at least some of the data. It may be possible in this embodiment to rewrite the stored data. But, the particular manner of data-entry in this embodiment may make rewriting difficult. A key point is that, in this embodiment, the medium cannot be accidentally erased. Due to the nature of the meaning of the data on or in the medium, it would be impractical to try to modify it unless the meanings of the data states were known and any encoding was known.

Variables associated with the construction and use of this embodiment include, inter alia, the type and properties of the medium; the type, size, shape, and density of the magnetically responsive particles embedded in the medium; the shape and depth of the medium; the power and spatial resolution achievable with the energy beam; and the sources, locations, and strengths of the externally applied magnetic fields.

Advantages of this embodiment include, inter alia: (1) The information/data density for the medium is greater than for conventional media. (2) The medium is immune to dirt and dust. (3) Scratches and scrapes on the surface do not degrade the medium. (4) The medium is resistant to accidental erasure. (5) The medium is not degraded by repeated reading. (6) The life-span of the medium is greater than of conventional media. (7) The medium can be used for covertly storing and encoding data and imagery including fingerprint and retinal-scan data. (8) The medium is difficult to counterfeit.

### SECOND REPRESENTATIVE EMBODIMENT

Data-storage devices according to this embodiment comprise micro- or nano-sized discrete loci of “ink” deposited on the surface of an appropriate substrate (e.g., thin film). The loci are configured as respective dots. The dots can be in an ordered or non-ordered array thereof. The ink of each dot contains a respective number of magnetically responsive particles. The loci are not limited to a round shape; they can be any desired shape such as polygonal, elliptical, oblong, etc. The loci also can be of any desired size (round dots are advantageous because a large number of them can be placed in a small area). Additionally, the spacing and density of the loci may be varied as a function of the particular application. The data-storage devices can be configured such that every locus carries a respective unit of data. Alternatively, by design, in certain applications such as security applications, it may be desirable that some of the loci not carry any data at all.

The substrate may be a film of any of various plastics, paper, woven or non-woven web, composite, or other substance. The substrate can be reinforced or non-reinforced. In consideration of the intended use of the data-storage device of this embodiment, the substrate desirably has physical properties (e.g., tear strength, flexibility, durability, hardness, etc.) that are appropriate for the intended use and that do not interfere with applied external magnetic fields.

The loci can be applied to the substrate by any of various techniques such as spraying, ink-jet printing, other printing, microlithography, or other suitable technique. The amount of data that can be stored is a function of the size of the loci; the smaller the locus, the potentially larger the data unit. In many instances, the size, density, and/or spacing of the loci will be determined by the particular sensor (“reader”) used to read the data from the data-storage device. Some readers have higher resolution and thus can read smaller and/or more closely spaced loci.

Preparing the magnetically responsive particles for surface deposition on the substrate can be performed as described in the first representative embodiment. For deposition, the particles desirably are suspended in a carrier fluid (liquid or gaseous) suitable for the particular device and technique used for deposition. The carrier fluid desirably is one that is readily removed (e.g., by evaporation) after deposition or readily cured into the loci. The carrier fluid can contain, if necessary, a binder to facilitate adhesion of the particles to the substrate. The viscosity of the ink should be practical, and can range from relatively free-flowing, as in many conventional pen inks, to a paint-like viscosity, for example. Drying or curing of the ink immobilizes the loci and the particles in them on the surface of the substrate.

In this embodiment, the magnetically responsive particles in the loci are magnetically oriented in a selective manner during the course of printing the loci on the substrate surface, but before the ink dries or cures. Selective exposure of the magnetically responsive particles in the loci to external magnetic fields in respective at least two non-parallel directions, so as to orient the particles in the loci selectively to the fields, can be achieved in a manner similar to that discussed above in the first representative embodiment, except that a laser or other energy beam is not used. fabrication and data-writing, each locus can represent a data unit in any of eight possible data states, compared to conventional binary (1,0) data storage. See the corresponding description in the first representative embodiment.

As noted in the first representative embodiment, data stored in a device according to the instant embodiment can comprise a two-dimensional array of N grey-levels sufficient to store an image, where each locus represents a respective pixel of the image.

According to this embodiment, the data can be stored in an encoded manner for increased security. Reference is made to the description of encoding in the first representative embodiment.

To read the data using a magnetic sensor, the loci desirably are pre-magnetized as discussed in the first representative embodiment. Magneto-resistive (or other) heads or arrays of heads can then be used to detect changes in particle orientations as functions of field strength and locus size, and as functions of the duration of the magnetic-field level.

In an alternative embodiment, the magnetic ink used for forming the loci on the surface of the substrate comprises a suspension of magnetically responsive particles in a thermoplastic carrier, or analogous carrier that can, but need not, penetrate into the substrate. The loci are “printed” (e.g., as respective “dots”) in the manner described generally above except that it is not necessary that the respective particles in each locus receive their respective magnetic orientations at time of printing. Rather, the loci can be printed on the surface of the substrate and magnetically oriented post hoc in a manner similar to that described in the first representative embodiment. Specifically, by using an ink in which the fluid carrier is a thermoplastic, the ink can be applied in a fluid state to the surface of the substrate to form the loci. The thermoplastic can be allowed to cure. Later, the loci can be selectively fluidized using a laser beam or other energy beam while applying respective magnetic fields to the loci to enter the respective data units in the loci. Upon removal of the energy beam from the locus, the thermoplastic re-cures and thus restrains the respective particles to maintain their orientations.

Variables associated with the construction and use of this embodiment include, inter alia: the type and properties of the substrate and covering medium; the type, size, shape, and density of the magnetically responsive particles in the particle suspension (“ink”) used for forming the loci; the drying or curing properties of the ink; the shape and depth of the device; and the sources, locations, and strengths of the externally applied magnetic fields.

Advantages of this embodiment include, inter alia: (1) The information/data density achieved by the device is greater than for conventional media. (2) The device is immune to dirt and dust. (3) Scratches and scrapes on the surface of the device do not degrade functioning of the device. (4) The data stored in the device cannot be accidentally erased. (5) The device is not degraded by repeated reading. (6) The life-span of the device is greater than of conventional media. (7) The device can be used for covertly storing and encoding data and imagery including fingerprint and retinal-scan data. (8) The device is difficult to counterfeit.

### THIRD REPRESENTATIVE EMBODIMENT

This embodiment is similar in many ways to the first representative embodiment, and common features of both embodiments are not discussed below. There are two principal differences between the two embodiments.

First, the medium in the instant embodiment is transparent to light of a second laser light source. The second laser light source typically is not the “first” laser that is used for magnetically orienting the particles in the loci. The first laser is specifically selected for its ability to cause localized fluidization of the medium; the second laser desirably does not cause fluidization of the medium.

Second, the magnetically responsive particles in the medium are formulated and/or configured to be reflective to the light produced by the second laser, especially whenever the particles have been magnetically oriented in the desired respective direction. With loci in or on the medium satisfying these criteria, the medium can be read optically (using the second laser to illuminate each locus) as well as being read magnetically or instead of being read magnetically. For optical reading, the respective orientation of the particles in an illuminated locus produces a reflected light signal that is a function of the orientation of the particles in the locus. This reflected light signal is “read” using an optical sensor. Other details of this embodiment are as described above in the first representative embodiment.

In one or more of the embodiments, as applicable, various alternatives are possible, as follows: (a) Other suitable media can be used to suspend the magnetically responsive particles, such as (but not limited to) glass-like compounds, salts, or other materials exhibiting suitable phase-changing properties when exposed to the energy beam. Salts would undergo a phase change from solid to liquid. Phase-change media allow for a dramatic change in mobility of the particles. (b) Any of various UV-curable epoxies is another candidate material for embedding magnetically responsive particles in their final orientations. Alternatively, any of various heat-curable epoxies or resins can be used. (c) The various orientations of the magnetically responsive particles also or alternatively can be identified without the need to preserve their individual magnetizations. (d) During data reading, the device can be magnetized in one direction and read. Then, the device can be magnetized in a second, third, . . . , etc., direction(s) and read repeatedly to determine even more decisively the orientations of the particles.

### FOURTH REPRESENTATIVE EMBODIMENT

In this embodiment the medium is a viscous medium (e.g., thermoplastic resin, fiber slurry, etc.) that is doped with magnetically responsive particles. and shaped into a desired form (e.g., credit-card form) or applied to a desired region of a substrate (e.g., banknote or the like). (See first representative embodiment.) Curing can be performed with or without application of a magnetic field. If performed with application of a magnetic field, the field strength and/or direction can be configured to change (e.g., randomly) at different locations on the medium, thereby creating a random or semi-random background “pattern” of the particles. Alternatively, the background can comprise an array of loci that are deliberately magnetically oriented as discussed above. If curing is performed in the absence of a magnetic field, a completely random background “pattern” of magnetically responsive particles in the medium can result.

The medium is then printed or embossed with a distinctive (e.g., unique) number, such as an account number on a check or serial number on a banknote or other document. The medium is read, including reading of its random or semi-random magnetic background as well as the printed or embossed number. The resulting data, which can be stored in a database, uniquely link the printed or embossed number with the background magnetic pattern, thereby providing a unique ID for the card, document, or banknote.

During reading of the card, banknote, or document, the obtained data are authenticated using a computer connected to or provided with the database. If the number on the card, banknote, or document does not correlate to the particular semi-random or random magnetic background pattern stored in the database and associated with the number, then the card, banknote, or document is rejected as counterfeit. This also allows the card, banknote, or document to be “tracked” by the database.

As an alternative or in addition, the background can be made detectable using other means such as ultraviolet (UV) radiation. For example, UV-sensitive particles can be added to the medium instead of or in addition to the magnetically responsive particles.

In yet another alternative, the number is printed or embossed on a medium formed by printing an ordered, semi-random, or random arrangement of loci or other symbols.

This embodiment also can be used to associate unique magnetically printed two-dimensional “artifacts” that already exist on each U.S. banknote with the unique serial number of the banknote. This occurs during the currency-printing process when the “borders” between magnetic and non-magnetic inks are formed.

Several of the embodiments can be used in current applications such as hard drives for computers as well as compact audio and video disks.

Whereas the invention has been described in connection with several representative embodiments, it will be understood that it is not limited to those embodiments. On the contrary, the invention is intended to encompass all modifications, alternatives, and equivalents as may be included within the spirit and scope of the invention, as defined by the appended claims.

What is claimed is:

1. A data-storage device, comprising:
a medium;
multiple, discrete, data-containable loci located in or on the medium; and
an alignment restraint;
wherein each data-containable locus includes magnetically responsive particles that are magnetically alignable in a respective selected one of at least two selectable non-parallel directions by application thereto of a respective magnetic field, the selected direction corresponding to a respective unit of data; and
the alignment restraint is configured to retain the respective magnetic alignments of the particles in the loci after removal of the respective magnetic fields.

2. The device of claim 1, wherein:
the medium is three-dimensional and includes at least a portion in which magnetically responsive particles are dispersed; and
the data-containable loci are respective regions in the portion containing the particles.

3. The device of claim 2, wherein:
the medium further comprises a substantially two-dimensional substrate having a surface contacting the three-dimensional medium; and
the portion containing the magnetically responsive particles is adjacent the surface of the two-dimensional substrate.

4. The device of claim 2, wherein:
the magnetically responsive particles are substantially uniformly distributed in the medium; and
the data-containable loci are distributed throughout the medium.

5. The device of claim 4, wherein:
the medium has a composition that fluidizes upon exposure to an energy beam and that returns to a non-fluid condition upon removal of the energy beam;
the loci are situated to allow selective exposure thereof to the energy beam to fluidize the medium at the selected locus and thus allow the magnetically responsive particles of the selected locus to align with a magnetic field applied to the locus; and
the alignment restraint is a characteristic of the medium by which the medium at a locus returns to a non-fluid condition upon removal of the energy beam from the locus.

6. The device of claim 2, wherein:
the medium has a composition that fluidizes upon exposure to an energy beam and that returns to a non-fluid condition upon removal of the energy beam;
the loci are situated to allow selective exposure thereof to the energy beam to fluidize the medium at the selected locus and thus allow the magnetically responsive particles of the selected locus to align with a magnetic field applied to the locus; and
the alignment restraint is a characteristic of the medium by which the medium at a locus returns to a non-fluid condition upon removal of the energy beam from the locus.

7. The device of claim 2, wherein the medium is configured as a three-dimensional card.

8. The device of claim 1, wherein:
the medium comprises a substantially two-dimensional substrate that includes a surface; and
the loci are distributed on the surface.

9. The device of claim 8, wherein:
the loci comprise respective dots of a suspension of magnetically responsive particles in a cured but re-fluidizable carrier on the surface of the medium; and
the alignment restraint is a characteristic of the carrier by which the carrier in a locus inhibits changes in magnetic orientation of the respective particles in the locus after magnetic orientation of the respective particles.

10. The device of claim 8, further comprising a protective layer extending over at least a portion of the surface so as to cover the loci.

11. The device of claim 8, wherein the medium is configured substantially as a document.

12. A device containing stored, readable data, comprising:
a medium;
multiple, discrete, data-containable loci located in or on the medium, the loci including respective magnetically responsive particles that are magnetically aligned in a respective selected one of at least two selectable non-parallel directions, the selected orientation direction of particles in a particular locus corresponding to a respective unit of data stored in the locus; and
an alignment restraint configured to retain the respective magnetic alignments of the particles in the loci.

13. The device of claim 12, wherein the data as stored in the loci are spatially encoded.

14. The device of claim 12, wherein:
the medium is three-dimensional and includes at least a portion in which magnetically responsive particles are dispersed; and
the loci are respective regions in the portion containing the dispersed particles.

15. The device of claim 14, wherein the medium is configured as a three-dimensional card.

16. The device of claim 12, wherein:
the medium comprises a substantially two-dimensional substrate that includes a surface; and
the loci are distributed on the surface.

17. The device of claim 16, wherein the medium is configured substantially as a document.

18. A method for storing data, comprising:
providing a supportive medium having at least two dimensions;
distributing on or in the at least two dimensions an amount of magnetically responsive particles sufficient to provide multiple data-containable loci on or in the medium, respectively, wherein each locus contains respective magnetically responsive particles, the particles being magnetically alignable in a respective one of at least two non-parallel directions to provide at least two respective, distinguishable states of data; and
adding respective data units to the loci by subjecting the loci to respective directions of magnetic fields corresponding to the respective data units in the loci.

19. The method of claim 18, wherein:
the medium is provided as having a surface; and
adding respective data units comprises (i) forming a first group of discrete loci and subjecting the first group to a magnetic field oriented in a first direction to record respective data units in the first data state, (ii) forming a second group of discrete loci on the surface and subjecting the second group to a magnetic field in a second direction that is non-parallel to the first direction to record respective data units in the second data state, and (iii) for each of any remaining data states, forming respective additional groups of loci on the surface and subjecting each of the additional groups to a respective magnetic field in a respective direction that is non-parallel to any of the other directions to record respective data units in the respective data state.

20. The method of claim 18, wherein:
the medium is provided with a region containing a distribution of magnetically responsive particles; and
adding respective data units comprises (i) selectively subjecting the loci in the region to an energy beam sufficient to fluidize the respective loci, and (ii) while the loci are fluidized, subjecting the locus to a respective direction of a magnetic field so as to add the respective data to the locus.

21. The method of claim 20, wherein selectively subjecting a locus to the energy beam re-fluidizes the medium at the locus.

22. The method of claim 20, wherein:
the magnetically responsive particles at a particular locus are in a carrier; and
selectively subjecting the locus to the energy beam re-fluidizes the carrier at the locus.

23. The method of claim 20, wherein the energy beam is a laser beam.

24. The method of claim 18, further comprising spatially encoding the loci.
